(19) United States
(12) Patent Application Publication
(10) Pub. No.: US 2025/0382447 A1
(43) Pub. Date: Dec. 18, 2025

(54) VULCANISABLE RUBBER MIXTURE, VULCANISED MATERIAL AND RUBBER PRODUCT

(71) Applicant: Continental Reifen Deutschland GmbH, Hannover (DE)

(72) Inventors: Andreas Wolf, Hannover (DE); Lena Müller, Lauenhagen (DE); Carla Recker, Hannover (DE); Hubert Hirschlag, Laatzen (DE); Catarina Nardi Tironi, Hannover (DE); Marion Puppa, Wedemark (DE); Armand Gabriel Becheanu-Böke, Langenhagen (DE); Kristen Schwekendiek, Wunstorf (DE); Thorsten Torbrügge, Langenhagen (DE); Norbert Müller, Nienhagen (DE)

(73) Assignee: Continental Reifen Deutschland GmbH, Hannover (DE)

(21) Appl. No.: 19/139,892

(22) PCT Filed: Dec. 12, 2023
(86) PCT No.: PCT/DE2023/200249

§ 371 Date: Jun. 17, 2025

(30) Foreign Application Priority Data
Dec. 20, 2022 (DE) 10 2022 213 973.9

(51) Int. Cl. C08L 9/06; B60C 1/00; C08K 3/06; C08K 3/36

(52) U.S. Cl. CPC C08L 9/06; B60C 1/00; C08K 3/06; C08K 3/36; C08L 2205/025; C08L 2205/035; C08L 2207/324

(57) ABSTRACT

A vulcanizable rubber compound including a) LTG diene rubbers selected from the group consisting of butadiene and styrene-butadiene rubbers having a glass transition temperature Tg, measured by DSC, in the range from −120° C. to −30° C., b) silicas, c) specific polyetheramines in a combined part by weight in the range from 0.1 to 10 phr, and d) diene rubbers different from the LTG diene rubbers.

The invention relates to a vulcanizable rubber compound, to a vulcanizate producible therefrom and to a rubber product, in particular a pneumatic vehicle tire, containing this vulcanizate.

The automobile industry is one of the industrial sectors that have faced fundamental challenges since the beginning of the 21st century while being defined by numerous technological innovations. Growing customer awareness of environmental issues such as emission profiles and resource efficiency requires new concepts for mobility. At the same time, the demand for improved vehicle features and the requirements in respect of driving safety are increasing. Meeting these challenges is not only an undertaking for the actual vehicle manufacturers. In practice, many of these issues are greatly influenced by the properties of vehicle tires, and so the optimization of tire properties is an important area of innovation.

A major component for optimizing the properties of vehicle tires and other rubber products, such as belts, drive belts and hoses, are the vulcanizable rubber compounds used for production and the rubber materials to be obtained thereby by vulcanization. A number of relevant properties of pneumatic vehicle tires, for example wet grip, rolling resistance and abrasion behavior, are for example closely linked to the composition of the rubber material of the tread. Therefore, the focus of many research efforts is on the optimization of the properties of the rubber compositions used, which are regularly subject to very high requirements. At the same time, there are conflicts of objectives with respect to numerous properties of vehicle tires, meaning that these properties cannot be optimized independently of one another other and that improving one parameter can lead to deterioration of another parameter.

In recent decades, significant advances have been made in the field of composition development. A key innovation here was, for example, the at least partial replacement of carbon black fillers by silicon-containing compounds, in particular silicon dioxide compounds, such as fumed silica or precipitated silica.

EP 2725059 A1 discloses that the combination of polyetheramines and silica can yield advantageous rubber compounds having in particular an improved level of performance with respect to abrasion behavior and to the conflict of objectives between rolling resistance and wet grip. Moreover, it was found that improved processing properties can be obtained in corresponding rubber compounds. Further information on the technological background of polyetheramines is disclosed, for example, in WO 2013/092526 A1, US 2008/033082 A1 and WO 2016/030469 A1.

Even though the vulcanizable rubber compounds known from the prior art can achieve overall advantageous results in many respects, the corresponding compositions and the vulcanizates producible therefrom are in many cases still regarded as in need of improvement with respect to application-relevant properties, especially in order to meet the requirements of modern pneumatic vehicle tires for high-performance applications.

It was a primary object of the present invention to overcome or at least reduce the disadvantages of the prior art and to provide an advantageous vulcanizable rubber compound and a corresponding vulcanizate producible therefrom that has an advantageous profile of properties.

In particular, it was an object of the present invention to provide a vulcanizable rubber compound having outstanding processing properties, it being desirable that the need for chemical compounds potentially harmful to health and/or the environment, in particular guanidine accelerators, can be reduced.

Moreover, it was an object of the present invention to provide a vulcanizable rubber compound and corresponding vulcanizates producible therefrom that have outstanding rolling properties, in particular an advantageous rolling resistance, good braking properties and advantageous handling properties.

Furthermore, it was an object of the present invention to provide a vulcanizable rubber compound and corresponding vulcanizates producible therefrom that have outstanding mechanical properties, especially with respect to stiffness and improved abrasion properties.

In particular, it was an object of the present invention to optimally resolve existing conflicts of objectives between processing properties, mechanical properties and rolling properties.

In this connection, it was an additional object of the present invention that the vulcanizable rubber compounds and vulcanizates to be provided should be producible as far as possible using production processes and materials that are already in use today in the field of rubber processing.

It was a further object of the present invention to provide a corresponding rubber product comprising the vulcanizate to be provided, in particular a pneumatic vehicle tire having advantageous properties.

The inventors of the present invention have now found that, surprisingly, the above-described objects can be achieved when vulcanizable rubber compounds comprise not only diene rubber and silica but also specific parts by weight of specific polyetheramines and butadiene rubber or styrene-butadiene rubber having a low glass transition temperature, as defined in the claims.

The aforementioned objects are accordingly achieved by the subject matter of the invention, as defined in the claims. Preferred embodiments according to the invention will become apparent from the dependent claims and from the discussions hereunder.

In particularly preferred embodiments, embodiments that are referred to as preferred hereunder are combined with features of other embodiments that are referred to as preferred. Combinations of two or more of the embodiments that are referred to as particularly preferred hereunder are thus most particularly preferred. Likewise preferred are embodiments in which a feature of one embodiment that is referred to as preferred to a certain extent is combined with one or more further features of other embodiments that are referred to as preferred to a certain extent. Features of preferred vulcanizates, rubber products and uses will become apparent from the features of preferred vulcanizable rubber compounds.

Where the following text discloses for a compound constituent, for example the diene rubbers or the polyetheramines, not only specific amounts/parts of said compound constituent but also preferred embodiments of the compound constituent, the text especially also discloses the specific amounts/parts of the preferred-embodiment compound constituents. Moreover, it is disclosed that, in the case of corresponding specific total amounts/total parts of the compound constituents, at least some of the compound constituents may be of a preferred embodiment and it is especially also disclosed that preferred-embodiment compound constituents may in turn be present in the specific amounts/parts within the specific total amounts or total parts.

The invention relates to a vulcanizable rubber compound comprising:
a) one or more LTG diene rubbers selected from the group consisting of butadiene and styrene-butadiene rubbers having a glass transition temperature Tg, measured by DSC, in the range from −120° C. to −30° C.,
b) one or more fillers selected from the group consisting of silicas,
c) one or more polyetheramines in a combined part by weight in the range from 0.1 to 10 phr,
the polyetheramines being selected from the group consisting of polyetheramines of formula I):

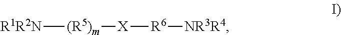

where R¹, R², R³ and R⁴ are each independently hydrogen or either branched or unbranched hydrocarbon radicals having 1 to 10 carbon atoms, where m is 0 or 1, where R⁵ and R⁶ are each independently either branched or unbranched hydrocarbon chains having 1 to 10 carbon atoms,
where X is a polyether chain of formula II):

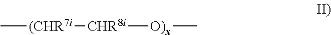

where x is in the range from 2 to 30, where R⁷ⁱ and R⁸ⁱ in each monomer unit i are, in each case, each independently and independently of the other monomer units in the polyether chain hydrogen or hydrocarbon radicals having 1 or 2 carbon atoms, and
d) one or more diene rubbers different from the LTG diene rubbers.

Vulcanizable rubber compounds per se and typical components thereof and also customary production processes for obtaining corresponding vulcanizable rubber compounds, especially by mixing of the components, are well known to a person skilled in the field of rubber processing.

In line with standard practice, the above-defined constituents of the vulcanizable rubber compound are each used as “one or more”. As is customary in the industry, the expression “one or more” refers to the chemical nature of the corresponding chemical compounds and not to the molar amount thereof. For example, the vulcanizable rubber compound may solely comprise SBR as diene rubber, which would mean that the vulcanizable rubber compound comprises a multiplicity of the corresponding molecules.

Where the following text indicates parts by weight, they are in many cases indicated as combined parts by weight of the one or more components, as is customary in the industry, thereby expressing that the part by weight of the correspondingly formed components taken together meets the corresponding criteria.

The measure phr (parts per hundred parts of rubber by weight) used here is the customary indication of quantity in the rubber industry for compound formulations and indicates the parts by weight of the components in the rubber compound based on the weight of the high-molecular-weight rubbers (GPC-determined weight-average molar mass Mw of greater than 60 000 g/mol) present in the rubber compound, with the combined part by weight of said high-molecular-weight rubbers in the rubber compound corresponding to 100 phr. The measure phf (parts per hundred parts of filler by weight) is analogously the customary indication of quantity in the rubber industry for compound formulations, in particular for coupling agents for fillers, based on the weight of the fillers present in the rubber compound. In the context of the present invention, the measure phf is based only on the silicas which are present in the vulcanizable rubber compound and the combined part by weight of which corresponds to 100 phf, meaning that other fillers that may be present, such as carbon black, are not included in the calculation of phf.

The vulcanizable rubber compound according to the invention comprises at least one diene rubber. In line with the understanding of a person skilled in the art, diene rubbers refer to rubbers that are obtained by (co)polymerization of dienes and/or cycloalkenes and thus have C═C double bonds either in the main chain or in the side groups. It can be considered to be an advantage of the vulcanizable rubber compound according to the invention that it is highly flexible with respect to the diene rubbers to be used, and so it is possible in principle to use all customary diene rubbers in the industry, where they are not the LTG diene rubbers further characterized hereinbelow. A person skilled in the art will understand that, besides the LTG diene rubbers, at least one further type of diene rubber which is not a butadiene rubber or styrene-butadiene rubber having a glass transition temperature Tg, measured by DSC, in the range from −120° C. to −30° C. is therefore always used in combination with the LTG diene rubbers. In this respect, according to the inventors, preference is however given to a vulcanizable rubber compound according to the invention, wherein the one or more diene rubbers are selected from the group consisting of natural polyisoprene, synthetic polyisoprene, epoxidized polyisoprene, butadiene rubber, solution-polymerized styrene-butadiene rubber, emulsion-polymerized styrene-butadiene rubber, polynorbornene, ethylene-propylene-diene rubber, nitrile rubber, acrylate rubber, styrene-isoprene-butadiene terpolymer, butyl rubber and halobutyl rubber, wherein the one or more diene rubbers are preferably selected from the group consisting of natural polyisoprene (NR), synthetic polyisoprene (IR), butadiene rubber (BR), solution-polymerized styrene-butadiene rubber (SSBR) and emulsion-polymerized styrene-butadiene rubber (ESBR), wherein the one or more diene rubbers are particularly preferably selected from the group consisting of solution-polymerized styrene-butadiene rubber and emulsion-polymerized styrene-butadiene rubber. In this respect, preference is additionally or alternatively also given to a vulcanizable rubber compound according to the invention, wherein at least one of the diene rubbers, preferably all of the one or more diene rubbers, is a diene rubber which is end group-modified and/or modified along the chain, preferably a diene rubber which is end group-modified. The modification may be one or more functional groups selected from the group consisting of hydroxyl groups, ethoxy groups, epoxy groups, siloxane groups, amino groups, aminosiloxane groups, carboxyl groups, phthalocyanine groups and silane-sulfide groups.

SBR, BR and IR/NR in particular have been found to be suitable diene rubbers for obtaining vulcanizable rubber compounds that can be converted by vulcanization into particularly effective vulcanizates.

Preference is therefore initially given to a vulcanizable rubber compound according to the invention, wherein the vulcanizable rubber compound comprises, in addition to the LTG diene rubber, styrene-butadiene rubber, preferably solution-polymerized styrene-butadiene rubber, as diene rubber, preferably in a part by weight in the range from 50 to 98 phr, particularly preferably in the range from 55 to 96 phr and most particularly preferably in the range from 60 to 90 phr.

Preference is additionally or alternatively given to a vulcanizable rubber compound according to the invention, wherein the vulcanizable rubber compound comprises, in addition to the LTG diene rubber, butadiene rubber as diene rubber, preferably in a part by weight in the range from 1 to 35 phr, particularly preferably in the range from 2 to 30 phr and most particularly preferably in the range from 5 to 25 phr. The butadiene rubber used in addition to the LTG diene rubber may be, for example, so-called high-cis or low-cis butadiene rubbers, a high-cis butadiene rubber referring to polybutadiene having a mass-based cis content of 90% or higher.

In turn, preference is additionally or alternatively given to a vulcanizable rubber compound according to the invention, wherein the vulcanizable rubber compound comprises natural polyisoprene and/or synthetic polyisoprene, preferably natural polyisoprene, as diene rubber, preferably in a combined part by weight in the range from 1 to 30 phr, particularly preferably in the range from 2 to 20 phr and most particularly preferably in the range from 5 to 15 phr. However, also conceivable are parts by weight in the range from 60 to 100 phr, preferably 60 to 80 phr, especially for applications for truck tires. The natural polyisoprene and/or the synthetic polyisoprene may be either cis-1,4-polyisoprene or 3,4-polyisoprene. However, preference is given to the use of cis-1,4-polyisoprenes, in particular with a mass-based cis-1,4 content of 90% or higher.

For optimal adaptation of the physicochemical/mechanical properties of the producible vulcanizates to the particular application requirements, it has been found to be advantageous to mix two or more diene rubbers together. Preference is accordingly given to a vulcanizable rubber compound according to the invention, wherein the vulcanizable rubber compound comprises two or more, preferably three or more, different diene rubbers as diene rubber, the vulcanizable rubber compound particularly preferably comprising SBR and NR and/or BR, most particularly preferably SBR, NR and BR.

Preference is additionally or alternatively given to a vulcanizable rubber compound according to the invention, wherein the diene rubber(s) has/have a weight-average molar mass Mw, measured by means of GPC, in the range from 150 000 to 5 000 000 g/mol, preferably in the range from 250 000 to 2 500 000 and particularly preferably in the range from 300 000 to 1 500 000. In the context of the present invention, determination of the number-average or weight-average or centrifuge-average molar mass is effected by gel permeation chromatography according to DIN 55672-1: 2016-03 (GPC with tetrahydrofuran as eluent, polystyrene standard; size exclusion chromatography).

The vulcanizable rubber compound according to the invention comprises one or more fillers selected from the group consisting of silicas. In the context of the present invention, use is made of the German term “Kieselsäure” [silicic acid], which is customary in the industry, in the original German text of this application, the relevant chemical compounds sometimes also being referred to as “Silika” on the basis of the English term “silica”. For a skilled person in the rubber processing industry, this historical German term refers to amorphous, i.e., noncrystalline, silicon dioxide, in particular so-called fumed silica and precipitated silica. In other words, the vulcanizable rubber compound according to the invention is a rubber compound comprising one or more fillers selected from the group consisting of fumed silica and precipitated silica, particularly preferably precipitated silica.

Preference is fundamentally given to a vulcanizable rubber compound according to the invention, wherein the one or more fillers have a nitrogen surface area (BET surface area) according to DIN ISO 9277:2014-01 in the range from 35 to 400 m²/g, preferably in the range from 35 to 350 m²/g, particularly preferably in the range from 85 to 320 m²/g and most particularly preferably in the range from 120 to 235 m²/g. Preference is additionally or alternatively given to a vulcanizable rubber compound according to the invention, wherein the one or more fillers have a CTAB surface area according to ASTM D 3765-03 in the range from 30 to 400 m²/g, preferably in the range from 30 to 330 m²/g, particularly preferably in the range from 80 to 300 m²/g and most particularly preferably in the range from 115 to 200 m²/g.

With respect to the amounts of filler that can be used, the inventors have found that the vulcanizable rubber compounds according to the invention advantageously exhibit outstanding results even for a high content of filler. However, according to the inventors, the solution identified in the context of the present invention exhibits the greatest advantages especially in the case of a medium content of filler. Preference is accordingly given to a vulcanizable rubber compound according to the invention, wherein the vulcanizable rubber compound comprises the one or more fillers in a combined part by weight in the range from 5 to 250 phr, preferably in the range from 20 to 180 phr, particularly preferably in the range from 30 to 140 phr and most particularly preferably in the range from 40 to 110 phr.

Besides the silicas to be used according to the invention, further fillers may additionally also be present, thereby allowing specific adaptation of the properties of the vulcanizable rubber compound. Preference is given to a vulcanizable rubber compound according to the invention, wherein the vulcanizable rubber compound comprises one or more further fillers selected from the group consisting of carbon black, aluminum hydroxide, titanium dioxide, magnesium oxide and phyllosilicates, the combined part by weight of the further fillers being preferably in the range from 0.1 to 100 phr and particularly preferably in the range from 0.5 to 50 phr. The carbon black used is preferably a carbon black having an iodine adsorption number to ASTM D 1510 of 30 to 250 g/kg, preferably 30 to 180 g/kg and particularly preferably 40 to 130 g/kg, and a DBP number to ASTM D 2414 of 30 to 200 ml/100 g, preferably 70 to 200 ml/100 g and particularly preferably 90 to 200 ml/100 g.

The vulcanizable rubber compound according to the invention comprises at least one polyetheramine of a specific structure. Polyetheramines are well known to a person skilled in the art. They are polyether polyols, the terminal hydroxyl groups of which have been converted into amino groups in an amination reaction, thus yielding polyamines. In the case of amination of the particularly preferred linear, i.e., unbranched, polyether diols, the polyetheramines are accordingly diamines of a polyalkylene glycol. The underlying polyether diols are preferably prepared from alkylene oxides, for example butylene oxide, ethylene oxide or propylene oxide. Polyetheramines are commercially available, in particular from Huntsman, for example under the trade names Jeffamine D-230, ED-600, ED-900 or EDR-148.

The polyetheramine to be used according to the invention is selected from the group consisting of polyetheramines of formula I):

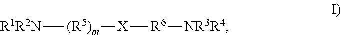

where R¹, R², R³ and R⁴ are each independently hydrogen or either branched or unbranched hydrocarbon radicals having 1 to 10 carbon atoms, where m is 0 or 1, where R⁵ and R⁶ are each independently either branched or unbranched hydrocarbon chains having 1 to 10 carbon atoms,
where X is a polyether chain of formula II):

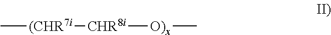

where x is in the range from 2 to 30, where R⁷ⁱ and R⁸ⁱ in each monomer unit i are, in each case, each independently and independently of the other monomer units in the polyether chain hydrogen or hydrocarbon radicals having 1 or 2 carbon atoms.

The R¹, R², R³ and R⁴ organic radicals define the radicals of the amino groups of the diamine and are produced especially from the substances used for the amination reaction. In line with the understanding of a person skilled in the art, these radicals are in principle independent of each other, meaning that, for example, R¹ can be hydrogen, even if R² is a hydrocarbon radical. In this respect, preference is given to a vulcanizable rubber compound according to the invention, wherein R¹, R², R³ and R⁴ are each independently hydrogen or either branched or unbranched, preferably unbranched, hydrocarbon radicals having 1 to 5 carbon atoms, preferably having 2 to 5 carbon atoms. Particular preference is given to a vulcanizable rubber compound according to the invention, wherein at least one of the R¹ and R² radicals and/or one of the R³ and R⁴ radicals is hydrogen. Most particular preference is given to a vulcanizable rubber compound according to the invention, wherein the R¹ and R³ radicals and/or the R² and R⁴ radicals are identical. Especial preference is given to a vulcanizable rubber compound according to the invention, wherein the R¹, R², R³ and R⁴ radicals are hydrogen.

One of the amino groups may be bonded to the polyether chain X either directly (m=0) or via a hydrocarbon chain (m=1). In preferred polyetheramines, owing to preparation from alkylene oxides, one of the amino groups is bonded directly to the polyether chain X (m=0), whereas the other amino group is bonded via an R⁶ hydrocarbon chain, which would ultimately be effectively the last building block of the polyether chain; however, this last building block no longer has an oxygen atom as a result of the amination and can accordingly no longer be regarded as part of the polyether chain X. Preference is therefore initially given to a vulcanizable rubber compound according to the invention, wherein R⁵ and R⁶ are each independently either branched or unbranched hydrocarbon chains having 1 to 5 carbon atoms, preferably having 2 or 3 carbon atoms. In this respect, particular preference is given to a vulcanizable rubber compound according to the invention, wherein m=0, wherein R⁶ is preferably an either branched or unbranched hydrocarbon chain having 2 or 3 carbon atoms, particularly preferably a branched or unbranched hydrocarbon chain having 3 carbons atoms.

The polyether chain X comprises x repeating units. Preference is given to a vulcanizable rubber compound according to the invention, wherein x is in the range from 2 to 15.

In each unit of the polyether chain X, i.e., in the different monomer units identified here by the running number i that accordingly runs from i=1 to i=x, R⁷ⁱ and R⁸ⁱ are fundamentally independent of each other, specifically not only R⁷ⁱ and R⁸ⁱ in each monomer unit but also all R⁷ⁱ and all R⁸ⁱ in the polyether chain. Because of the fundamental advantageousness of alkylene oxides of comparatively short chain length, preference is given to a vulcanizable rubber compound according to the invention, wherein R⁷ⁱ and R⁸ⁱ in each monomer unit i are, in each case, each independently and independently of the other monomer units in the polyether chain hydrogen or methyl groups. Particular preference is given to a vulcanizable rubber compound according to the invention, wherein, in each monomer unit i, at least one of the R⁷ⁱ and R⁸ⁱ radicals is hydrogen in each case.

In this respect, a person skilled in the art will understand that the nature of the R⁷ⁱ and R⁸ⁱ radicals depends especially on the chemical nature of the chemical compounds used in polyetheramine preparation, in particular the alkylene oxides used, and that more complex polyetheramines can be obtained especially when different alkylene oxides are mixed together in polyetheramine preparation.

According to the inventors, preference is given to a vulcanizable rubber compound according to the invention, wherein the polyether chain comprises one or more first monomer units i1 of formula IV):

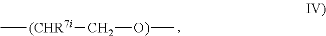

where R⁷ⁱ is preferably identical for all first monomer units i₁, where R⁷ⁱ is particularly preferably a methyl group for all first monomer units i₁, and/or
wherein the polyether chain comprises one or more second monomer units i₂ of formula V):

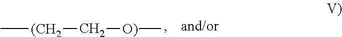

wherein the polyether chain comprises one or more third monomer units i₃ of formula VI):

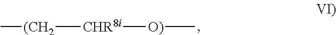

where R⁸ⁱ is preferably identical for all third monomer units i₃, where R⁸ⁱ is particularly preferably a methyl group for all third monomer units i₃, the polyether chain preferably consisting of these monomer units.

With regard to these monomer units, preference is fundamentally given to vulcanizable rubber compounds according to the invention, wherein the number of first monomer units i₁ in the polyether chain x₁ is in the range from 1 to 7, preferably in the range from 2 to 6 and particularly preferably in the range from 2 to 5 and/or wherein the number of second monomer units i₂ in the polyether chain x₂ is in the range from 1 to 15, preferably in the range from 2 to 12 and particularly preferably in the range from 3 to 10 and/or wherein the number of third monomer units i₃ in the polyether chain x₃ is in the range from 1 to 7, preferably in the range from 2 to 6 and particularly preferably in the range from 2 to 5. In this respect, particular preference is given to a vulcanizable rubber compound according to the invention, wherein the combined number of first monomer units i₁ and third monomer units i₃ in the polyether chain x_{1/3} is in the range from 2 to 10, preferably in the range from 3 to 7.

In this respect, most particular preference is initially given to a vulcanizable rubber compound according to the invention, wherein the polyether chain consists of first monomer units i₁ preferably to an extent of more than 50%, particularly preferably to an extent of more than 75% and particularly preferably substantially completely, the number of first monomer units i₁ in the polyether chain x₁ being in the range from 1 to 5 and preferably in the range from 2 to 4. Corresponding polyetheramines are commercially available, for example, under the trade name Jeffamine D-230, where x₁ is about 2.5.

Particular preference is additionally or alternatively also given to a vulcanizable rubber compound according to the invention having mixed polyether chains, i.e., wherein the polyether chain comprises two or more, preferably three or more, monomer units selected from the group consisting of first monomer units i₁, second monomer units i₂ and third monomer units i₃, the polyether chain preferably consisting of these monomer units. Relevant to most applications are vulcanizable rubber compounds according to the invention, wherein at least some and preferably all of the two or more monomer units are randomly distributed in the polyether chain.

For mixed polyether chains, most particular preference is initially given to a vulcanizable rubber compound according to the invention, wherein the combined number of first monomer units i₁ and third monomer units i₃ in the polyether chain x_{1/3} is in the range from 2 to 5 and wherein the number of second monomer units i₂ in the polyether chain x₂ is in the range from 7 to 12. Corresponding polyetheramines are commercially available, for example, under the trade name Jeffamine ED-600, where x₂ is about 9 and x_{1/3} is about 3.6.

For mixed polyether chains, most particular preference is additionally or alternatively also given to a vulcanizable rubber compound according to the invention, wherein the combined number of first monomer units i₁ and third monomer units i₃ in the polyether chain x_{1/3} is in the range from 4 to 8 and wherein the number of second monomer units i₂ in the polyether chain x₂ is in the range from 10 to 15. Corresponding polyetheramines are commercially available, for example, under the trade name Jeffamine ED-900, where x₂ is about 12.5 and x_{1/3} is about 6.

The inventors regard especially the use of such polyetheramines, typical representatives of which are the commercial products Jeffamine D-230 and ED-600, as preferable for achieving the object of the invention.

Particular preference is accordingly given to a vulcanizable rubber compound according to the invention, wherein the one or more polyetheramines are selected from the group consisting of:
polyetheramines of formula VII):

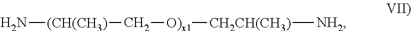

where x₁ is in the range from 2 to 6, preferably in the range from 2 to 5, particularly preferably in the range from 2 to 4 and most particularly preferably in the range from 2 to 3, and
polyetheramines of formula VIII):

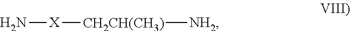

where X is a polyether chain consisting of two or more monomer units selected from the group consisting of
first monomer units i_{1b} of formula IV_{b}):

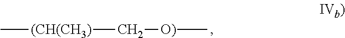

second monomer units i_{2b} of formula V_{b}):

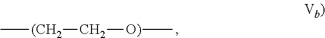

and
third monomer units i_{3b} of formula VI_{b}):

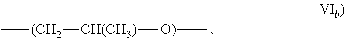

where the combined number of first monomer units i_{1b} and third monomer units i_{3b} in the polyether chain x_{1b/3b} is in the range from 2 to 5, where the number of second monomer units i_{2b} in the polyether chain x_{2b} is in the range from 8 to 10.

On the basis of the preparation or preparability of the polyetheramines, fundamental preference is also given to a vulcanizable rubber compound according to the invention, wherein the one or more polyetheramines are preparable by polymerization of an alkylene oxide with subsequent amination, the alkylene oxide being preferably selected from the group consisting of butylene oxide, ethylene oxide, propylene oxide and mixtures of these compounds, preferably propylene oxide. Particular preference is additionally or alternatively also given to a vulcanizable rubber compound according to the invention, wherein the one or more polyetheramines are saturated compounds.

The polyetheramines that are preferably used are compounds of comparatively short chain length. Specifically, particular preference is given to a vulcanizable rubber compound according to the invention, wherein the one or more polyetheramines have a weight-average molar mass in the range from 100 to 800 g/mol, preferably in the range from 130 to 650 g/mol and particularly preferably in the range from 190 to 400 g/mol.

For further optimization of the properties of the vulcanizable rubber compound according to the invention and the vulcanizates producible therefrom, different polyetheramines may be combined, with especially combinations of preferred polyetheramines, for example as can be achieved by combining the commercial products Jeffamine D-230 and ED-600, being considered advantageous by the inventors. Preference is accordingly given to a vulcanizable rubber compound according to the invention, wherein the vulcanizable rubber compound comprises two or more different polyetheramines.

Irrespective of the exact chemical nature of the polyetheramines, the inventors have successfully identified particularly advantageous parts by weight of these components, by means of which the above-described objects can be achieved particularly well. Specifically, preference is given to a vulcanizable rubber compound according to the invention, wherein the vulcanizable rubber compound comprises the one or more polyetheramines in a combined part by weight in the range from 0.2 to 8 phr and preferably in the range from 0.4 to 6 phr.

The vulcanizable rubber compound according to the invention further comprises LTG diene rubbers. The term “LTG diene rubbers” means “low Tg” diene rubbers and is used in the context of the present invention to clearly identify the specific butadiene and styrene-butadiene rubbers having a low glass transition temperature and to distinguish them from the other diene rubbers.

The LTG diene rubbers are butadiene and/or styrene-butadiene rubbers having a glass transition temperature Tg, measured by DSC, in the range from −120° C. to −30° C., which is lower than for customary BR and SBR rubbers. Corresponding BR and SBR rubbers are known in principle to a person skilled in the art and commercially available. Corresponding SBR LTG rubbers are available, for example, under the trade names Sprintan SLR 3402 (from Trinseo) or Nipol NS612 (from Zeon). Suitable BR LTG rubbers are available, for example, under the trade name PBT030 (from Zeon). Information on the technological background is disclosed, for example, in EP 2853558 A1.

In the context of the present invention, glass transition temperature Tg is determined in the customary manner by dynamic scanning calorimetry (DSC) to DIN 53765: 1994-03 or ISO 11357-2: 1999-03, calibrated DSC with low-temperature device, calibration according to instrument type and manufacturer's instructions, sample in aluminum crucible with aluminum lid, cooling to temperatures lower than −120° C. at 10° C./min).

In this respect, the inventors have succeeded in identifying particularly preferred LTG diene rubbers by means of which vulcanizable rubber compounds according to the invention having particularly positive property profiles can be obtained.

Preference with respect to the glass transition temperatures is given to a vulcanizable rubber compound according to the invention, wherein the glass transition temperature Tg of the one or more LTG diene rubbers, measured by DSC, is in the range from −100° C. to −30° C., preferably in the range from −95° C. to −30° C., particularly preferably in the range from −95° C. to −45° C., most particularly preferably in the range from −95° C. to −55° C. and especially preferably in the range from −85° C. to −55° C. Preference is additionally or alternatively given to a vulcanizable rubber compound according to the invention, wherein the glass transition temperature Tg of the one or more LTG diene rubbers, measured by DSC, is −40° C. or lower, preferably −50° C. or lower.

In this respect, particular preference is given to a vulcanizable rubber compound according to the invention, wherein the one or more LTG diene rubbers are selected from the group consisting of styrene-butadiene rubbers having a glass transition temperature Tg, measured by DSC, in the range from −120° C. to −30° C. Preference is additionally or alternatively given to a vulcanizable rubber compound according to the invention, wherein the one or more LTG diene rubbers are selected from the group consisting of solution-polymerized styrene-butadiene rubbers, preferably anionically solution-polymerized styrene-butadiene rubbers. Preference is given to a vulcanizable rubber compound according to the invention, wherein at least one and preferably all of the LTG diene rubbers are selected from the group consisting of styrene-butadiene rubbers having a proportion by mass of styrene-derived units in the range from 10% to 30% and preferably in the range from 15% to 25%.

The inventors have found that the use of specific functionalized LTG diene rubbers in particular results in effective vulcanizable rubber compounds according to the invention. Corresponding LTG diene rubbers are disclosed, for example, in EP 2853558 A1. The functionalization may be monofunctionalization or polyfunctionalization and occur along the polymer chain and/or at the end of the chain. Preference is accordingly given to a vulcanizable rubber compound according to the invention, wherein at least one and preferably all of the LTG diene rubbers are selected from the group consisting of butadiene and styrene-butadiene rubbers, preferably styrene-butadiene rubbers, which have been functionalized with phthalocyanine groups and/or hydroxyl groups and/or epoxy groups and/or silane-sulfide groups. Particular preference is given to a vulcanizable rubber compound according to the invention, wherein at least one and preferably all of the LTG diene rubbers are selected from the group consisting of butadiene and styrene-butadiene rubbers, preferably styrene-butadiene rubbers, which have been functionalized with hydroxyl groups.

With respect to the weight-average molar mass Mw, the range also specified as preferred for the other diene rubbers is advantageous. Preference is therefore given to a vulcanizable rubber compound according to the invention, wherein the one or more LTG diene rubbers have a weight-average molar mass Mw, measured by means of GPC, in the range from 150 000 to 5 000 000 g/mol, preferably in the range from 250 000 to 2 500 000 and particularly preferably in the range from 300 000 to 1 500 000. With regard to BR LTG rubber, particular preference is given to vulcanizable rubber compounds, wherein the one or more butadiene rubbers have a weight-average molar mass Mw, measured by means of GPC, in the range from 200 000 to 2 000 000 g/mol, preferably in the range from 250 000 to 1 000 000 and particularly preferably in the range from 300 000 to 750 000.

According to the inventors, it is advantageous when the vulcanizable rubber compounds comprise a comparatively large amount of LTG diene rubber and the proportion of other diene rubbers is correspondingly low. Preference is accordingly given to a vulcanizable rubber compound according to the invention, wherein the vulcanizable rubber compound comprises the one or more LTG diene rubbers in a combined part by weight in the range from 50 to 100 phr, particularly preferably in the range from 60 to 98 phr and most particularly preferably in the range from 70 to 95 phr.

Besides the diene rubbers, the fillers, the polyetheramines and the LTG diene rubbers, what may be used in the vulcanizable rubber compounds according to the invention are further typical constituents which, for example, are used to influence the physicochemical properties, for example the processing and vulcanization properties, of the vulcanizable rubber compounds or to optimize the mechanical properties of the vulcanizates producible therefrom.

In this respect, preference is initially given to a vulcanizable rubber compound according to the invention, wherein the vulcanizable rubber compound comprises one or more further added substances, the further added substances being preferably selected from the group consisting of reinforcer resins, coupling agents and plasticizers, the vulcanizable rubber compound preferably comprising the further added substances in a combined part by weight in the range from 10 to 100 phr, preferably in the range from 20 to 80 phr and particularly preferably in the range from 30 to 60 phr.

An example that may be mentioned is a vulcanizable rubber compound according to the invention, wherein the reinforcer resins are selected from the group consisting of resorcinol-formaldehyde resins, in particular resorcinol-hexamethoxymethylmelamine resins (HMMM) or resorcinol-hexamethylenetetramine resins (HEXA), and modified phenolic resins. A person skilled in the field of rubber processing is easily able to distinguish resins from diene rubbers, and in practice this is especially accomplished via the average molar mass. In this respect, an example that may be mentioned is a vulcanizable rubber compound according to the invention, wherein the one or more further resins have a weight-average molar mass Mw, measured by means of GPC, in the range from 200 to 50 000 g/mol, preferably in the range from 400 to 40 000 g/mol, particularly preferably in the range from 600 to 30 000 g/mol and most particularly preferably in the range from 800 to 20 000 g/mol.

An example that may also be mentioned is a vulcanizable rubber compound according to the invention, wherein the coupling agents are selected from the group consisting of 3-mercaptopropyltriethoxysilane, 3-thiocyanatopropyltrimethoxysilane and 3,3′-bis(triethoxysilylpropyl) polysulfides having 2 to 8 sulfur atoms, the vulcanizable rubber compound preferably comprising the coupling agents in a combined part by weight in the range from 0.2 to 30 phf and preferably in the range from 1 to 15 phf.

Moreover, an example that may be mentioned is a vulcanizable rubber compound according to the invention, wherein the plasticizers are selected from the group consisting of mineral oils, synthetic plasticizers, fatty acids, fatty acid derivatives, plasticizer resins, factices, glycerides, terpenes, biomass-to-liquid oils (BTL oils) and rubber-to-liquid oils (RTL oils), the vulcanizable rubber compound preferably comprising the plasticizers in a combined part by weight in the range from 1 to 100 phr, preferably in the range from 10 to 80 phr and particularly preferably in the range from 20 to 60 phr.

Preference is additionally or alternatively given to a vulcanizable rubber compound according to the invention, wherein the vulcanizable rubber compound comprises one or more further additives, the further additives being preferably selected from the group consisting of methylene donors, antiaging agents, for example N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), 2,2,4-trimethyl-1,2-dihydroquinoline (TMQ), activators, for example zinc oxide and fatty acids, waxes, mastication aids, for example 2,2′-dibenzamidodiphenyldisulfide (DBD), and processing aids. Preference is given to a vulcanizable rubber compound according to the invention, wherein the vulcanizable rubber compound comprises the further additives in a combined part by weight in the range from 0.1 to 20 phr, preferably in the range from 0.5 to 15 phr and particularly preferably in the range from 1 to 10 phr.

With regard to vulcanization behavior, preference is given to a vulcanizable rubber compound according to the invention, wherein the vulcanizable rubber compound comprises 0.5 to 8.0 phr, preferably 0.8 to 6 phr and particularly preferably 1 to 4 phr of sulfur. In this respect, preference is additionally or alternatively also given to a vulcanizable rubber compound according to the invention, wherein the vulcanizable rubber compound comprises further vulcanization constituents, the further vulcanization constituents being selected from the group consisting of crosslinkers, vulcanization retarders and vulcanization accelerators, for example thiazole accelerators, mercapto accelerators, sulfenamide accelerators, thiocarbamate accelerators, thiuram accelerators, thiophosphate accelerators, thiourea accelerators, xanthogenate accelerators or guanidine accelerators.

Particular preference is given to dispensing with guanidine accelerators, in particular diphenylguanidine. Preference is accordingly given to a vulcanizable rubber compound according to the invention, wherein the vulcanizable rubber compound comprises 2 phr or less, preferably 1 phr or less, particularly preferably 0.5 phr or less and most particularly preferably essentially 0 phr of guanidine accelerators, in particular diphenylguanidine.

The inventors have succeeded in identifying a further constituent which, in combination with the polyetheramines and the LTG diene rubbers, results in particularly advantageous vulcanizable rubber compounds and vulcanizates according to the invention that especially result in particularly advantageous rolling resistances and favorable braking properties and accordingly particularly advantageously resolve the conflict of objectives in this respect. These constituents to be advantageously used are a specific class of resins, namely hydrocarbon resins, the advantageous effects becoming apparent especially at high parts by weight of said resins. Particular preference is accordingly given to a vulcanizable rubber compound according to the invention, wherein the vulcanizable rubber compound additionally comprises:
d) one or more hydrocarbon resins in a combined part by weight in the range from 10 to 140 phr.

In line with the understanding of a person skilled in the art, hydrocarbon resins are resins which have carbon atoms and hydrogen atoms, though, especially depending on the raw materials used in production and on the methods used, heteroatoms, such as oxygen atoms in particular, may also be present to a low extent, the proportion by mass of heteroatoms in the hydrocarbon resin being preferably 5% or less, particularly preferably 1% or less, most particularly preferably 0.5% or less and especially preferably 0.1% or less, based on the mass of the hydrocarbon resin. Suitable hydrocarbon resins are disclosed, for example, in DE 102015210840 A1.

Preference is given to a vulcanizable rubber compound according to the invention, wherein the one or more hydrocarbon resins are selected from the group consisting of aromatic and aliphatic hydrocarbon resins, preferably selected from the group consisting of terpene, C5, C9, coumarone-indene and dicyclopentadiene (DCPD) resins, and aromatic resins prepared from α-methylstyrene and/or styrene, and copolymers of the monomers of these resin types, particularly preferably selected from the group consisting of aromatic resins prepared from α-methylstyrene and/or styrene.

Particular preference is given to a vulcanizable rubber compound according to the invention, wherein the one or more hydrocarbon resins are selected from the group consisting of aliphatic C5 resins and hydrocarbon resins of alpha-methylstyrene and/or styrene, preferably selected from the group consisting of hydrocarbon resins of alpha-methylstyrene and/or styrene, preferably alpha-methylstyrene.

Preference is given to a vulcanizable rubber compound according to the invention, wherein the one or more hydrocarbon resins have a weight-average molar mass Mw, measured by means of GPC, in the range from 500 to 4000 g/mol, preferably in the range from 1000 to 3000 g/mol and particularly preferably in the range from 1500 to 2500 g/mol. Preference is additionally or alternatively given to a vulcanizable rubber compound according to the invention, wherein the one or more hydrocarbon resins have an average molar mass Mz (centrifuge-average) in the range from 500 to 10 000 g/mol, particularly preferably in the range from 750 to 5000 g/mol, most particularly preferably in the range from 1000 to 4000 g/mol and especially preferably in the range from 1250 to 3000 g/mol. Preference is additionally or alternatively also given to a vulcanizable rubber compound according to the invention, wherein the one or more hydrocarbon resins have a softening point according to ASTM E 28 (ring and ball) in the range from 10° C. to 180° C., preferably in the range from 60° C. to 150° C., particularly preferably in the range from 70° C. to 120° C. and most particularly preferably in the range from 80° C. to 99° C.

Moreover, the inventors have succeeded in identifying particularly suitable parts by weight for the hydrocarbon resins. Specifically, preference is given to a vulcanizable rubber compound according to the invention, wherein the vulcanizable rubber compound comprises the one or more hydrocarbon resins in a combined part by weight in the range from 20 to 120 phr, preferably in the range from 25 to 110 phr and particularly preferably in the range from 30 to 100 phr. Preference is additionally or alternatively given to a vulcanizable rubber compound according to the invention, wherein the proportion by mass of the one or more hydrocarbon resins, based on the total mass of all plasticizers and resins in the vulcanizable rubber compound, is 30% or higher, preferably 60% or higher, particularly preferably 90% or higher and most particularly preferably substantially 100%.

From the vulcanizable rubber compounds according to the invention, vulcanizates and rubber products can be produced in a customary manner. The corresponding process for producing a vulcanizate or a rubber product comprises, besides producing the vulcanizable rubber compound according to the invention, additionally, for example, the step of:
x) vulcanizing the vulcanizable rubber compound according to the invention, preferably as part of a rubber blank, particularly preferably as part of an unvulcanized vehicle tire blank, for obtaining a vulcanizate, preferably as part of a rubber product, preferably as part of a pneumatic vehicle tire.

Here, the vulcanizable rubber compound according to the invention is vulcanized, for example, by the customary process in the tire industry, for example by sulfur-based crosslinking.

The invention accordingly also relates to a vulcanizate producible or produced by vulcanization of a vulcanizable rubber compound according to the invention. In this respect, preference is given to a vulcanizate according to the invention, wherein the vulcanizate is producible by vulcanization at a temperature in the range from 130° C. to 200° C., preferably in the range from 150° C. to 180° C.

The invention accordingly also relates to a rubber product comprising the vulcanizate according to the invention. An example that may be mentioned is a rubber product according to the invention, wherein the rubber product is selected from the group consisting of shoe soles, drive belts, hoses, conveyor belts, and belts. However, for substantially all cases, preference is given to a rubber product according to the invention, wherein the rubber product is a vehicle tire, preferably a pneumatic vehicle tire, the pneumatic vehicle tire preferably comprising the vulcanizate according to the invention in the tread.

Lastly, also disclosed is the use of a vulcanizable rubber compound according to the invention and/or a vulcanizate according to the invention in the production of rubber products, in particular vehicle tires.

The invention and preferred embodiments of the invention will be explained and described in more detail hereunder with reference to experiments.

### A. Production of Vulcanizable Rubber Compounds:

The vulcanizable rubber compounds were produced in three stages in a laboratory tangential mixer by the customary process in the rubber industry under customary conditions, comprising first preparing a base mixture containing all constituents except the vulcanization system (sulfur and vulcanization-influencing substances) in one or more mixing stages, followed by adding the vulcanization system thereto to yield the final compound.

The substances used in this connection are listed in Table 1.

TABLE 1
Substances used

| | |
|---|---|
| NR | Natural rubber |
| | (NR TSR) |
| BR | Butadiene rubber |
| | (trade name: Europrene Neocis BR 40, from Versalis) |
| SSBR1 | Solution-polymerized styrene-butadiene copolymer |
| | (trade name: Sprintan SLR-4601; from Trinseo; |
| | Tg = −25° C.) |
| SSBR2 | Solution-polymerized styrene-butadiene copolymer |
| | (trade name: Sprintan SLR 3402; from Trinseo |
| | Tg = −62° C., functionalized) |
| SSBR3 | Solution-polymerized styrene-butadiene copolymer |
| | (trade name: Nipol NS612; from Zeon |
| | Tg = −58.4° C.; Mw = 456 390 g/mol; functionalized with |
| | hydroxyl groups) |
| Filler | Precipitated silica |
| | (trade name: VN3, from Evonik) |
| Polyetheramines 1 | Polyetheramines of formula VII; x₁ ≈ 2.5 |
| | (trade name: Jeffamine D-230; from Huntsman) |
| Polyetheramines 2 | Polyetheramines of formula VIII; x_{1b/3b} ≈ 3.6 and x_{2b} ≈ 9 (trade |
| | name: Jeffamine ED-600; from Huntsman) |
| Silane | Bis(3-triethoxysilylpropyl)disulfides |
| | (trade name: Si266; from Evonik) |
| Plasticizer | Treated Distillate Aromatic Extracted; TDAE |
| HC resin | Poly-alpha-methylstyrene |
| | (trade name: Impera P1504; from Eastman |
| | Mz = 1500-2000 g/mol; softening temp. = 82-88° C.) |
| Additive 1 | Antiaging agent, 6PPD |
| Additive 2 | Antiozonant wax |
| Additive 3 | Zinc oxide |
| Additive 4 | Stearic acid |
| DPG | Diphenylguanidine |
| CBS | N-Cyclohexyl-2-benzothiazolesulfenamides |
| Sulfur | Sulfur |

Each of the vulcanizable rubber compounds was used to produce test pieces by vulcanization after t₉₅-t₁₀₀ (measured using a moving die rheometer to ASTM D 5289-19/ISO 6502) under pressure at 160° C. to 170° C., and material properties typical of the rubber industry were determined on the test pieces thus produced using the test methods specified in section B.

### B. Determination of the Physicochemical Properties of the Vulcanizates:

The following physicochemical properties were determined on the vulcanizable rubber compounds and the vulcanizates produced therefrom using the methods of determination listed in Table 2:

TABLE 2
Methods of determination used

| t10 & t90 | This corresponds to the time t to reach 10% or 90% |
|---|---|
| | crosslinking (S′max) according to ASTM D5289 from 2012, |
| | determined using a moving die rheometer at 160° C. |
| Rb 70° C. | Rebound resilience at 70° C. according |
| | to ISO 4662: 2017-06 |
| M300 | Stress value (modulus) at 300% elongation at room |
| | temperature to DIN 53504: 2017-03 |
| tan d | Loss factor tan δ at 0° C. over the temperature sweep |
| (0° C.) | of the dynamic-mechanical measurement at a measurement |
| (strain | frequency of 10 Hz and a dynamic deformation of 0.2%. In |
| constant) | accordance with ISO 4664-1: 2011-11. |
| tan d max | Maximum loss factor tan δ max at 55° C. as the maximum |
| (DKF | value over the strain sweep from dynamic-mechanical |
| 55° C.) | measurement at a frequency of 10 Hz. |
| tan d | Loss factor tan d (55° C.) at 55° C. according |
| (55° C.) | to ISO 4664-1: 2011-11, at 16 Hz, 50N preload, 25N |
| 50/30N | amplitude force, 5 min temperature adjustment time, |
| | measured value recorded after 30 s testing time. |
| E′(0.15%) − | Difference between the dynamic storage modulus at 8% |
| E′(8%) | strain (E′(8%)) and 0.15% strain (E′(0.15%)) |
| | from dynamic-mechanical measurement at a frequency |
| | of 10 Hz at 55° C. according to DIN 53513: 1990-03 |
| Abrasion | Abrasion at room temperature according to DIN ISO |
| | 4649: 2014-03 |

### C. 1st Series of Tests:

In the 1st series of tests, nine vulcanizable rubber compounds were produced, the composition of which is specified in Table 3.

TABLE 3
Vulcanizable rubber compounds according to
the 1st series of tests (all data in phr)

| Constituents | V1 | V2 | V3 | V4 | E1 | E2 | V5 | E3 | E4 |
|---|---|---|---|---|---|---|---|---|---|
| NR | 10 | 10 | 10 | 10 | 10 | 10 | 10 | 10 | 10 |
| BR | 18 | 18 | 18 | 18 | 18 | 18 | 18 | 18 | 18 |
| SSBR1 | 72 | 72 | 72 | — | — | — | — | — | — |
| SSBR2 | — | — | — | 72 | 72 | 72 | — | — | — |
| SSBR3 | — | — | — | — | — | — | 72 | 72 | 72 |
| Filler | 95 | 95 | 95 | 95 | 95 | 95 | 95 | 95 | 95 |
| Polyetheramine 1 | — | 2.31 | — | — | 2.31 | — | — | 2.31 | — |
| Polyetheramine 2 | — | — | 6.02 | — | — | 6.02 | — | — | 6.02 |
| Silane | 6.84 | 6.84 | 6.84 | 6.84 | 6.84 | 6.84 | 6.84 | 6.84 | 6.84 |
| Plasticizer | 35 | 35 | 35 | 35 | 35 | 35 | 35 | 35 | 35 |
| Additive 1 | 2 | 2 | 2 | 2 | 2 | 2 | 2 | 2 | 2 |
| Additive 2 | 2 | 2 | 2 | 2 | 2 | 2 | 2 | 2 | 2 |
| Additive 3 | 2.5 | 2.5 | 2.5 | 2.5 | 2.5 | 2.5 | 2.5 | 2.5 | 2.5 |
| Additive 4 | 2.5 | 2.5 | 2.5 | 2.5 | 2.5 | 2.5 | 2.5 | 2.5 | 2.5 |
| DPG | 2 | — | — | 2 | — | — | 2 | — | — |
| CBS | 2 | 2 | 2 | 2 | 2 | 2 | 2 | 2 | 2 |
| Sulfur | 2 | 2 | 2 | 2 | 2 | 2 | 2 | 2 | 2 |

The part by weight of the polyetheramines was adjusted in each case so as to introduce a constant molar amount.

The material properties determined on the associated vulcanizates are summarized in Table 4.

TABLE 4
Material properties for the 1st series of tests

| | V1 | V2 | V3 | V4 | E1 | E2 | V5 | E3 | E4 |
|---|---|---|---|---|---|---|---|---|---|
| t10/min | 3.4 | 2.0 | 1.2 | 3.0 | 2.4 | 1.1 | 3.1 | 2.3 | 1.2 |
| t90/min | 16.5 | 12.5 | 8.6 | 14.0 | 9.8 | 5.0 | 13.2 | 10.8 | 6.2 |
| Rb 70° C./% | 49.1 | 47.8 | 47.5 | 53.7 | 53.9 | 55.7 | 49.8 | 50.0 | 52.2 |
| M300/MPa | 7.2 | 7.4 | 7.2 | 6.6 | 7.4 | 8.3 | 6.6 | 6.9 | 7.8 |
| E′(0.15%) − | 6.0 | 7.8 | 8.3 | 6.3 | 6.6 | 6.1 | 7.1 | 7.1 | 6.4 |
| E′(8%) | | | | | | | | | |
| DKF 55 C./ | | | | | | | | | |
| MPa | | | | | | | | | |
| Attritus/mm³ | 128 | 128 | 132 | 92 | 88 | 86 | 98 | 95 | 91 |

The results of the 1st series of tests compiled in Table 4 show that polyetheramines 1 and 2 exhibit an advantageous acceleration effect, which is shown in a reduction of the t10 and t90 times. This means that it is advantageously possible to achieve an advantageous acceleration effect without using DPG and to achieve a lower vulcanization time.

When SSBR1 is used, the use of polyetheramine 1 in V2 and polyetheramine 2 in V3 leads to an undesirable decrease in RB 70° C. compared to V1. whereas when SSBR2 is used in E1 and E2 and SSBR3 is used in E3 and E4, these values are consistently improved compared to the respective DPG-based references V4 and V5. In samples V1 to V3, it is moreover evident that the use of polyetheramine 1 in V2 and polyetheramine 2 in V3 leads to an undesirable increase in E′(0.15%)-E′(8%) compared to V1, which indicates an undesirable rise in filler-filler interaction (Payne effect). In inventive samples E1 to E4 by contrast, it remains surprisingly substantially constant compared to V4 and V5 within the limits of accuracy of measurement or even shows a reduction. This means that the experiments show that an improved rolling resistance is apparent for the samples according to the invention.

Furthermore, when SSBR1 is used, the use of polyetheramine 1 in V2 and polyetheramine 2 in V3 results in an undesirable decrease in M300 compared to V1, whereas this value is advantageously increased in the inventive samples compared to the respective reference, which means that the vulcanizates are stiffer and exhibit better handling properties.

Furthermore, abrasion is surprisingly also improved in the inventive samples, whereas in samples V1 to V3, improvements are not apparent; instead, even a deterioration may be assumed in some cases.

### D. 2nd Series of Tests:

In the 2nd series of tests, eight further vulcanizable rubber compounds were produced, the composition of which is specified in Table 5.

TABLE 5
Vulcanizable rubber compounds according to the 2nd series of tests (all data in phr)

| Constituents | V6 | E5 | V7 | E6 | V8 | E7 | V9 | E8 |
|---|---|---|---|---|---|---|---|---|
| NR | 10 | 10 | 10 | 10 | 10 | 10 | 10 | 10 |
| SSBR3 | 90 | 90 | 90 | 90 | 90 | 90 | 90 | 90 |
| Filler | 120 | 120 | 120 | 120 | 120 | 120 | 120 | 120 |
| Polyetheramine 1 | — | 2.31 | — | 2.31 | — | 2.31 | — | 2.31 |
| Silane | 8.64 | 8.64 | 8.64 | 8.64 | 8.64 | 8.64 | 8.64 | 8.64 |
| HC resin | — | — | 30 | 30 | 60 | 60 | 90 | 90 |
| Plasticizer | 90 | 90 | 60 | 60 | 30 | 30 | — | — |
| Additive 1 | 2 | 2 | 2 | 2 | 2 | 2 | 2 | 2 |
| Additive 2 | 2 | 2 | 2 | 2 | 2 | 2 | 2 | 2 |
| Additive 3 | 2.5 | 2.5 | 2.5 | 2.5 | 2.5 | 2.5 | 2.5 | 2.5 |
| Additive 4 | 2.5 | 2.5 | 2.5 | 2.5 | 2.5 | 2.5 | 2.5 | 2.5 |
| DPG | 2 | — | 2 | — | 2 | — | 2 | — |
| CBS | 2 | 2 | 2 | 2 | 2 | 2 | 2 | 2 |
| Sulfur | 2 | 2 | 2 | 2 | 2 | 2 | 2 | 2 |

The material properties determined on the associated vulcanizates are summarized in Table 6.

TABLE 6
Material properties for the 2nd series of tests

| | V6 | E5 | V7 | E6 | V8 | E7 | V9 | E8 |
|---|---|---|---|---|---|---|---|---|
| t10/min | 4.1 | 3.5 | 4.2 | 3.4 | 4.2 | 3.3 | 2.8 | 2.8 |
| t90/min | 21.5 | 20.0 | 19.6 | 20.5 | 21.0 | 19.6 | 20.1 | 18.8 |
| tan d (0° C.) | 0.342 | 0.342 | 0.461 | 0.477 | 0.691 | 0.701 | 0.705 | 0.736 |
| temp sweep | | | | | | | | |
| E′(0.15%) − | 2.8 | 3.4 | 3.6 | 3.7 | 4.5 | 4.3 | 6.3 | 5.3 |
| E′(8%) DKF | | | | | | | | |
| 55° C./MPa | | | | | | | | |
| tan d max | 0.226 | 0.220 | 0.223 | 0.219 | 0.241 | 0.222 | 0.291 | 0.275 |
| (DKF) | | | | | | | | |
| tan d (55° C.) | 0.204 | 0.206 | 0.213 | 0.209 | 0.238 | 0.228 | 0.303 | 0.294 |
| 50/30N | | | | | | | | |

The results of the 2nd series of tests compiled in Table 6 demonstrate the acceleration effect of polyetheramine 1.

From a comparison of samples V6 and E5, it is evident that the replacement of DPG by polyetheramine 1 in the inherently advantageous inventive samples with a high filler content and high plasticizer content of plasticizer oil can result in an increase in E′(0.15%)-E′(8%), which in turn indicates an undesirable rise in filler-filler interaction (Payne effect). In contrast, the addition of the hydrocarbon resin advantageously results in a decrease, which is an indicator of improved rolling resistance. In line with this finding, the use of polyetheramine 1 also results in an improvement in the form of reduced values for tan d max (DKF) and tan d (55° C., temp sweep, force const) in the inventive samples containing hydrocarbon resin, which is also a predictor of better rolling resistance.

Moreover, improved indicators of braking properties are apparent for the inventive samples containing hydrocarbon resin, since tan d (0° C.) rises in these samples.

1. A vulcanizable rubber compound comprising:
a) one or more LTG diene rubbers selected from the group consisting of butadiene and styrene-butadiene rubbers having a glass transition temperature Tg, measured by DSC, in the range from −120° C. to −30° C.,
b) one or more fillers selected from the group consisting of silicas,
c) one or more polyetheramines in a combined part by weight in the range from 0.1 to 10 phr,
the polyetheramines being selected from the group consisting of polyetheramines of formula I): 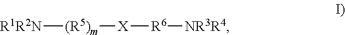
where R¹, R², R³ and R⁴ are each independently hydrogen or either branched or unbranched hydrocarbon radicals having 1 to 10 carbon atoms, where m is 0 or 1, where R⁵ and R⁶ are each independently either branched or unbranched hydrocarbon chains having 1 to 10 carbon atoms,
where X is a polyether chain of formula II): 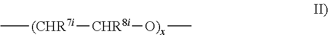
where x is in the range from 2 to 30, where R⁷ⁱ and R⁸ⁱ in each monomer unit i are, in each case, each independently and independently of the other monomer units in the polyether chain hydrogen or hydrocarbon radicals having 1 or 2 carbon atoms, and
d) one or more diene rubbers different from the LTG diene rubbers.

2. The vulcanizable rubber compound as claimed in claim 1, wherein the vulcanizable rubber compound comprises styrene-butadiene rubber as diene rubber, and/or wherein the vulcanizable rubber compound comprises butadiene rubber as diene rubber,
and/or wherein the vulcanizable rubber compound comprises natural polyisoprene and/or synthetic polyisoprene as diene rubber.

3. The vulcanizable rubber compound as claimed in claim 1, wherein the vulcanizable rubber compound comprises the one or more fillers in a combined part by weight in the range from 5 to 250 phr.

4. The vulcanizable rubber compound as claimed in claim 1, wherein R⁷ⁱ and R⁸ⁱ in each monomer unit i are, in each case, each independently and independently of the other monomer units in the polyether chain hydrogen or methyl groups.

5. The vulcanizable rubber compound as claimed in claim 1, wherein the polyether chain comprises one or more first monomer units i1 of formula IV): 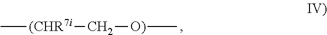
and/or
wherein the polyether chain comprises one or more second monomer units i₂ of formula V): 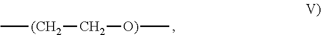
and/or
wherein the polyether chain comprises one or more third monomer units i₃ of formula VI):

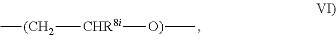

6. The vulcanizable rubber compound as claimed in claim 1, wherein the one or more polyetheramines are selected from the group consisting of:
polyetheramines of formula VII): 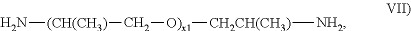
where x₁ is in the range from 2 to 6, and
polyetheramines of formula VIII): 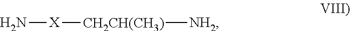
where X is a polyether chain consisting of two or more monomer units selected from the group consisting of
first monomer units i_{1b} of formula III_{b}): 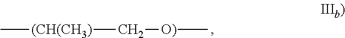
second monomer units i_{2b} of formula IV_{b}): 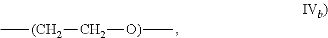
and
third monomer units i_{3b} of formula V_{b}): 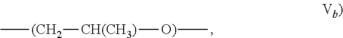
where the combined number of first monomer units i_{1b} and third monomer units i_{3b} in the polyether chain x_{1b/3b} is in the range from 2 to 5, where the number of second monomer units i_{2b} in the polyether chain x_{2b} is in the range from 8 to 10.

7. The vulcanizable rubber compound as claimed in-claim 1, wherein the LTG diene rubber(s) is/are selected from the group consisting of butadiene and styrene-butadiene rubbers which have been functionalized with phthalocyanine groups and/or hydroxyl groups and/or epoxy groups and/or silane-sulfide groups.

8. The vulcanizable rubber compound as claimed in-claim 1, wherein the vulcanizable rubber compound additionally comprises:
d) one or more hydrocarbon resins in a combined part by weight in the range from 10 to 140 phr.

9. A vulcanizate producible or produced by vulcanization of a vulcanizable rubber compound as claimed in claim 1.

10. A rubber product, in particular a pneumatic vehicle tire, comprising a vulcanizate as claimed in claim 9.
